(19) United States
(12) Patent Application Publication
(10) Pub. No.: US 2024/0157669 A1
(43) Pub. Date: May 16, 2024

(54) DISPLAY MODULE AND DISPLAY APPARATUS

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Shengxing ZHANG, Beijing (CN); Liqiang CHEN, Beijing (CN); Shuquan YANG, Beijing (CN)

(73) Assignees: CHENGDU BOE OPTOELECTRONICS TECHNOLOGY CO., LTD., Sichuan (CN); BOE TECHNOLOGY GROUP CO., LTD., Beijing (CN)

(21) Appl. No.: 17/910,951

(22) PCT Filed: Oct. 25, 2021
(86) PCT No.: PCT/CN2021/126199

§ 371 Date: Sep. 12, 2022

(30) Foreign Application Priority Data
Mar. 8, 2021 (CN) 202110250648.4

(51) Int. Cl. B32B 3/26; B32B 3/30; B32B 5/18; B32B 7/022; B32B 7/12; B32B 25/14; B32B 25/20; B32B 27/36; G06F 1/16

(52) U.S. Cl. CPC B32B 3/266; B32B 3/30; B32B 5/18; B32B 7/022; B32B 7/12; B32B 25/14; B32B 25/20; B32B 27/36; G06F 1/1618; B32B 2266/025; B32B 2274/00; B32B 2307/54; B32B 2307/56; B32B 2457/20

(57) ABSTRACT

A display module includes a display panel including a main body region, a first bendable region, a second bendable region and a back region, a buffer layer and a stress relief portion. The first bendable region and the second bendable region are both bent toward the back side of the display panel, and the back region is bent to be disposed opposite to the first bendable region. The buffer layer includes a first buffer portion corresponding to the main body region and a second buffer portion corresponding to the first bendable region, and an elastic modulus of the second buffer portion is less than that of the first buffer portion. The stress relief portion is configured to absorb and release a stress generated during a bending process of the second bendable region of the display panel.

### CROSS-REFERENCE TO RELATED APPLICATIONS

This application is a national phase entry under 35 USC 371 of International Patent Application No. PCT/CN2021/126199, filed on Oct. 25, 2021, which claims priority to Chinese Patent Application No. 202110250648.4, filed on Mar. 8, 2021, which are incorporated herein by reference in their entirety.

### TECHNICAL FIELD

The present disclosure relates to the field of display technologies, and in particular, to a display module and a display apparatus.

### BACKGROUND

With the development of display technologies, a flexible display panel has attracted more and more attention due to its advantages such as softness and an ability to be bent into a curved panel. A curved display apparatus with a certain angle (such as a curved screen and a waterfall display) made of the flexible display panel is favored by consumers due to its beautiful curves, comfortable feel, and high screen-to-body ratio.

A display module includes a support component (for example, which includes a support layer, a buffer layer, and a flexible support layer that are stacked), a display panel, and an encapsulation component (for example, which includes a polarizer, an encapsulation adhesive, and a cover glass that are stacked) that are stacked. After the display module is formed by the support component, the display panel and the encapsulation component through an assembling process, at least part of the display module is bent to form a desired curved surface at a target position of the display module.

### SUMMARY

In an aspect, a display module is provided. The display module includes a display panel, a buffer layer, and a stress relief portion. The display panel includes a main body region, a first bendable region, a second bendable region, and a back region; the first bendable region is located on a side of the main body region, the second bendable region is located on a side of the first bendable region away from the main body region, and the back region is located on a side of the second bendable region away from the main body region. The main body region, the first bendable region, the second bendable region and the back region are connected in sequence. The first bendable region is bent toward a back side of the display panel to form a curved surface. The second bendable region is bent toward the back side of the display panel, and the back region is bent to be disposed opposite to the first bendable region. The buffer layer is located on the back side of the display panel, and includes a first buffer portion and a second buffer portion arranged side by side in a first direction the display panel. The first buffer portion corresponds to the main body region, the second buffer portion corresponds to the first bendable region, and an elastic modulus of the second buffer portion is less than an elastic modulus of the first buffer portion. The first direction is a direction perpendicular to a boundary line between the main body region and the first bendable region. The stress relief portion is disposed on a side of the second bendable region proximate to the buffer layer, and is configured to absorb and release a stress generated during a bending process of the second bendable region of the display panel.

In some embodiments, the second buffer portion includes a plurality of buffer bars, each buffer bar extends in a second direction, and the plurality of buffer bars are arranged at intervals in the first direction. The second direction is an extending direction of the boundary line between the main body region and the first bendable region.

In some embodiments, the second buffer portion includes a plurality of holes arranged at intervals.

In some embodiments, a shape of a radial section of each hole may be a circle or an ellipse.

In some embodiments, a material of the first buffer portion includes polyethylene (PE) foam or polyester resin. And/or, a material of the second buffer portion includes thermoplastic polyurethane elastomer rubber or silicone rubber.

In some embodiments, the buffer layer further includes a first auxiliary layer and a second auxiliary layer. The first auxiliary layer is disposed on a side of both of the first buffer portion and the second buffer portion away from the display panel and being connected to the first buffer portion and the second buffer portion. The second auxiliary layer is disposed on a side of both of the first buffer portion and the second buffer portion proximate to the display panel and being connected to the first buffer portion and the second buffer portion.

In some embodiments, the first auxiliary layer and the second auxiliary layer are each a material layer having adhesiveness.

In some embodiments, the display module further includes a back film. The back film includes a first back sub-film and a second back sub-film. The first back sub-film is disposed between the display panel and the buffer layer, and corresponds to the main body region and the first bendable region of the display panel. The second back sub-film is disposed on the back side of the display panel, and corresponds to the back region of the display panel. An edge of the first back sub-film proximate to the second back sub-film exceeds an edge of the second buffer portion away from the first buffer portion in the first direction. The stress relief portion is disposed on a side of the first back sub-film away from the display panel, and is adhered to a portion of the first back sub-film exceeding the second buffer portion.

In some embodiments, the display module further includes a first adhesive layer. The first adhesive layer is disposed between the buffer layer and the first back sub-film. The stress relief portion is adhered to a sidewall of the first adhesive layer proximate to the second bendable region of the display panel, and a sidewall of the buffer layer proximate to the second bendable region of the display panel.

In some embodiments, the edge of the first adhesive layer proximate to the second bendable region of the display panel has at least one groove structure, and a part of the stress relief portion is embedded in the at least one groove structure.

In some embodiments, the display module further includes a support layer and a curved layer. The support layer is disposed on a side of the buffer layer away from the main body region and the first bendable region of the display panel. The curved layer is disposed on a side of the support layer away from the buffer layer and corresponding to the first bendable region of the display panel.

In some embodiments, the stress relief portion is further adhered to a sidewall of the support layer proximate to the second bendable region of the display panel, and a sidewall of the curved layer proximate to the second bendable region of the display panel.

In some embodiments, the curved layer is of a double-layer structure and is formed by folding a single-layer film structure in half; the sidewall of the curved layer proximate to the second bendable region of the display panel has a curved surface.

In some embodiments, the second back sub-film is located between the curved layer and the back region of the display panel, and is adhered to the curved layer.

In some embodiments, a material of the stress relief portion includes at least one of a Tuffy adhesive, an acrylate-based adhesive or a silicon-based adhesive.

In some embodiments, the display module further includes a protective film disposed on a side of the display panel away from the buffer layer. The protective film covers the second bendable region of the display panel, and in the first direction, an end of the protective film extends toward the first bendable region of the display panel, and another end of the protective film extends toward the back region of the display panel.

In another aspect, a display apparatus is provided. The display apparatus has a main display area and a curved surface area located on at least one side of the main display area. The display apparatus includes the display module according to any of the embodiments described above. The main body region of the display panel in the display module is located in the main display area, and the first bendable region of the display panel is located in the curved surface area.

### BRIEF DESCRIPTION OF THE DRAWINGS

In order to describe technical solutions in the present disclosure more clearly, the accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is a structural diagram of a display apparatus, in accordance with some embodiments;

FIG. 2 is a sectional view taken along a section line A-A in FIG. 1;

FIG. 3A is a structural diagram of a display module, in accordance with some embodiments;

FIG. 3B is a structural diagram of another display module, in accordance with some embodiments;

FIG. 4 is a structural diagram of a buffer layer, in accordance with some embodiments;

FIG. 5A is a partial enlargement view of the region A′ in FIG. 4;

FIG. 5B is another partial enlargement view of the region A′ in FIG. 4;

FIG. 6 is a sectional view taken along a section line B-B in FIG. 4;

FIG. 7A is a structural diagram of a first adhesive layer, in accordance with some embodiments;

FIG. 7B is a structural diagram of another first adhesive layer, in accordance with some embodiments; and

FIG. 7C is a structural diagram of yet another first adhesive layer, in accordance with some embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained on a basis of the embodiments of the present disclosure by a person of ordinary skill in the art shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, the terms such as “some embodiments”, “example”, or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Below, the terms “first” and “second” are only used for descriptive purposes, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of/the plurality of” means two or more unless otherwise specified.

In the description of some embodiments, the term “connected” and derivatives thereof may be used. For example, the term “connected” may be used in the description of some embodiments to indicate that two or more elements are in direct physical or electrical contact with each other.

The phrase “A and/or B” includes the following three combinations: only A, only B, and a combination of A and B.

As used herein, the term “if” is optionally construed as “when” or “in a case where”.

Exemplary embodiments are described herein with reference to sectional views and/or plan views as idealized exemplary accompanying drawings. In the accompanying drawings, thicknesses of layers and sizes of regions are enlarged for clarity. Thus, variations in shape relative to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing.

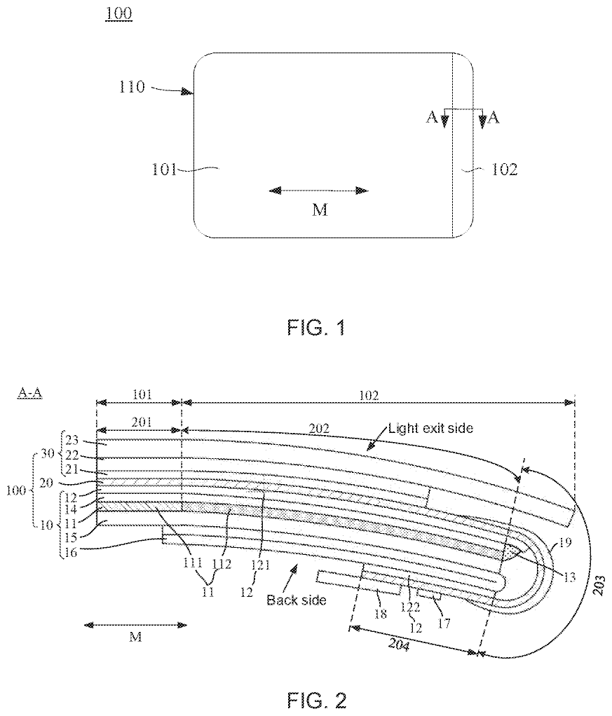

As shown in FIG. 1, some embodiments of the present disclosure provide a display apparatus 100, which may be any product or component having a display function, such as a television, a monitor, a notebook computer, a tablet computer, a mobile phone or a navigator.

The display apparatus 100 may be any of a curved display apparatus, a foldable display apparatus, a rollable display apparatus, or other display apparatuses with irregular shapes. For example, referring to FIG. 1, the display apparatus 100 may be a display apparatus with curved surface(s) on one side or two sides, which has a main display area 101 and a curved surface area 102.

In an example in which a border of the display apparatus 100 is in a shape of a rectangle or approximately a rectangle, the curved surface area 102 may be located on either of a left side and a right side of the main display area 101, or located on a lower side of the main display area 101, which is not specifically limited here. For example, referring to FIG. 1, the curved surface area 102 is located on the right side of the main display area 101.

Referring to FIG. 1, the display apparatus 100 includes a display module 110. Referring to FIG. 2, the display module 110 includes a support component 10, a display panel 20 and an encapsulation component 30 that are stacked. The display panel 20 is a flexible display panel.

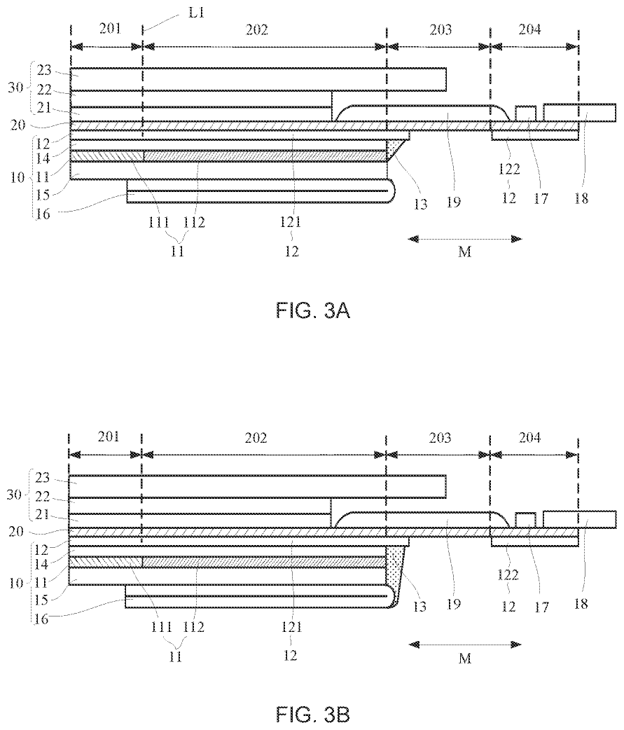

After the support component 10, the display panel 20 and the encapsulation component 30 are subjected to an assembling process, as shown in FIGS. 3A and 3B, a module structure in a planar state or a substantially planar state is formed. Then a region of the display module 110 that needs to form the curved surface area 102 is bent according to a preset angle through a bending process, so as to form the display module 110 in a curved state as shown in FIG. 2.

In the related art, in all support layer structures included in the support component 10, a part located in the main display area 101 of the display apparatus 100 is made of a same material as another part located in the curved surface area 102 of the display apparatus 100, and they are of an integral structure. A part of the support layer structures included in the support component 10 has a certain elasticity. During the process of bending the display module 110 to form a curved surface, the part of the support layer structures having elasticity located in the curved surface area 102 of the display apparatus 100 will be deformed. After the display module 110 is bent to form the curved surface, the part of the support layer structures located in the curved surface area 102 of the display apparatus 100 has a tendency to restore to be in the planar state due to an action of an elastic restoring force. That is, there is a rebound force (an elastic recovery force) inside the part. A problem of film layer separation is easy to occur between adjacent support layer structures due to an action of the rebound force.

Some embodiments of the present disclosure provide a display module 110, referring to FIG. 2, the display module 110 includes a display panel 20, a buffer layer 11 and a stress relief portion 13. The display panel 20 and the buffer layer 11 are stacked, and the buffer layer 11 is located on a back side of the display panel 20. The display panel has a light exit surface for displaying images, the back side refers to a side away from the light exit surface of the display panel 20, and a light exit side refers to a side proximate to the light exit surface of the display panel 20.

Referring to FIGS. 3A and 3B, the display panel 20 includes a main body region 201, a first bendable region 202, a second bendable region 203, and a back region 204. The first bendable region 202 is located on a side of the main body region 201, the second bendable region 203 is located on a side of the first bendable region 202 away from the main body region 201, and the back region 204 is located on a side of the second bendable region 203 away from the main body region 201. The main body region 201, the first bendable region 202, the second bendable region 203 and the back region 204 are connected in sequence.

Referring to FIGS. 2 and 3A, the main body region 201 is used to form the main display area 101 of the display apparatus 100. The first bendable region 202 is bent toward the back side of the display panel 20 to form the curved surface area 102 of the display apparatus 100. The second bendable region 203 is bent toward the back side of the display panel 20, and the back region 204 is bent to be disposed opposite to the first bendable region 202, so as to reduce a bezel width of the display apparatus 100.

For example, the main body region 201 is in a shape of a rectangle, the display panel 20 includes a single first bendable region 202, a single second bendable region 203 and a single back region 204. The first bendable region 202, the second bendable region 203 and the back region 204 are all located on a same side of the main body region 201.

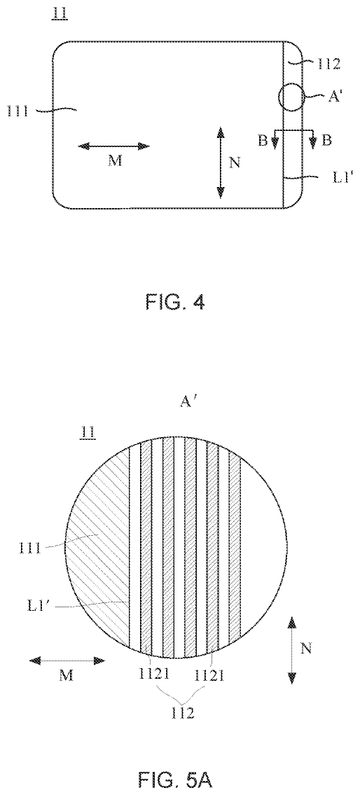

Referring to FIGS. 3A and 4, the buffer layer 11 includes a first buffer portion 111 and a second buffer portion 112 arranged side by side in a first direction M on the display panel 20. Referring to FIG. 3A, the first buffer portion 111 corresponds to the main body region 201, the second buffer portion 112 corresponds to the first bendable region 202, and an elastic modulus of the second buffer portion 112 is less than an elastic modulus of the first buffer portion 111. The first direction M is a direction perpendicular to a boundary line L1 of the main body region 201 and the first bendable region 202.

In the display module 110 provided in the embodiments of the present disclosure, referring to FIGS. 3A and 4, the buffer layer 11 adopts a segmented design, the buffer layer 11 includes the first buffer portion 111 and the second buffer portion 112, and the elastic modulus of the second buffer portion 112 is less than the elastic modulus of the first buffer portion 111, so that an elastic modulus of a portion of the buffer layer 11 corresponding to the first bendable region 202 of the display panel 20 (the second buffer portion 112) is reduced. As a result, the rebound force generated after the second buffer portion 112 is bent to form the curved surface is reduced, and a possibility of film separation of the display module 110 in the curved surface area 102 is reduced.

The stress relief portion 13 is disposed on a side of the second bendable region 203 proximate to the buffer layer, and the stress relief portion 13 is configured to absorb and release a stress generated during the bending process of the second bendable region 203 of the display panel 20.

During the bending process of the second bendable region 203 of the display panel 20, a portion of the second bendable region 203 proximate to the first bendable region 202 is subjected to the greatest stress, and has the greatest risk of cracks or fractures. The stress relief portion 13 plays a buffering role on the portion, absorbs part of the stress generated during the bending process of the portion, and releases a rebound force generated by the stress relief portion 13 through a deformation of the stress relief portion 13, so that the risk of cracks or fractures occurring in the portion of the second bendable region 203 proximate to the first bendable region 202 is reduced.

It will be noted that, in a case where the display apparatus 100 is a foldable display apparatus, a rollable display apparatus, or other display apparatuses with irregular shapes, an elastic modulus of a portion of the buffer layer 11 corresponding to a foldable region or a bendable region of the display panel 20 may be made less than an elastic modulus of a portion of the buffer layer 11 corresponding to another region (a planar region) of the display panel 20, so as to reduce a rebound force generated by the buffer layer 11 during a folding or a bending process of the display panel 20, and reduce a possibility of film separation of the display module 110 in the bendable region.

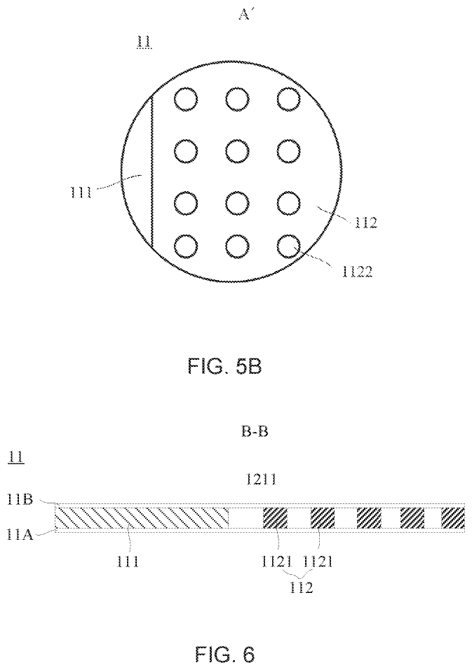

In some embodiments, referring to FIG. 5A, the second buffer portion 112 includes a plurality of buffer bars 1121, each buffer bar 1121 extends in a second direction N, and the plurality of buffer bars 1121 are arranged at intervals in the first direction M. The second direction N is an extending direction of the boundary line L1 of the main body region 201 and the first bendable region 202 (i.e., an extending direction L1′ of a boundary line of the first buffer portion 111 and the second buffer portion 112).

For example, before the second buffer portion 112 is bent to form the curved surface, a length of each buffer bar 1121 in the second direction N is the same as a dimension of the first buffer portion 111 in the second direction N, and a spacing between the plurality of buffer bars 1121 in the first direction M is 0.05 mm.

During the process of bending the display module 110 to form the curved surface, the second buffer portion 112 of the buffer layer 11 is subjected to a tensile stress in the first direction M. The plurality of buffer bars 1121 are arranged at intervals in the first direction M, and the spacing between two adjacent buffer bars 1121 may enable the buffer bars 1121 to deform in the first direction M, so that the rebound force of the buffer bars 1121 is released through the deformation of the buffer bars 1121.

In some embodiments, referring to FIG. 5B, the second buffer portion 112 includes a plurality of holes 1122 arranged at intervals. A shape of a radial section of a hole 1122 may be a circle, an ellipse, or other shapes, which is not specifically limited here. The hole 1122 may be a through hole or a blind hole. In a case where the hole 1122 is the blind hole, the hole 1122 may be provided in a surface of the second buffer portion 112 proximate to the display panel 20, or in a surface of the second buffer portion 112 away from the display panel 20, which is not specifically limited here. A deformation space of the second buffer portion 112 may be increased by providing the holes 1122 in the second buffer portion 112, so that part of the rebound force inside of the second buffer portion 112 by the deformation of the second buffer portion 112 may be released, and in turn, the rebound force of the second buffer portion 112 is reduced, and the possibility of film separation of the display module 110 is reduced.

It will be noted that, FIGS. 5A and 5B only exemplify two kinds of structures of the second buffer portion 112. Alternatively, the second buffer portion 112 may be grid-shaped or any other structure with a deformation space inside, so that the second buffer portion 112 may have a certain deformation after being subjected to a stress (a tensile stress or a compressive stress), and the rebound force inside the second buffer portion 112 may be released by the deformation of the second buffer portion 112, and in turn, the possibility of film separation in the bendable region of the display module 110 is reduced.

A material of the first buffer portion 111 includes polyethylene (PE) foam or polyester resin, and an elastic modulus of the material may reach 10 GPa or higher, so that it may not only buffer the display panel 20, but also prevent the main body region 201 of the display panel 20 from generating an unexpected plastic deformation due to an external force. And/or, a material of the second buffer portion 112 includes thermoplastic polyurethane elastomer rubber or silicone rubber, and an elastic modulus of the material is about 20 MPa, which is much less than a value of the elastic modulus of the first buffer portion 111. Compared with the first buffer portion 111, the second buffer portion 112 generates a smaller elastic recovery force (i.e., the rebound force) after being bent to form the curved surface, which may reduce the probability of film separation of the display module 110.

In some embodiments, referring to FIG. 6, the buffer layer 11 further includes a first auxiliary layer 11A and a second auxiliary layer 11B. The first auxiliary layer 11A is disposed on a side of both of the first buffer portion 111 and the second buffer portion 112 away from the display panel 20 (a lower side in FIG. 6), and is connected to the first buffer portion 111 and the second buffer portion 112. The second auxiliary layer 11B is disposed on a side of both of the first buffer portion 111 and the second buffer portion 112 proximate to the display panel 20 (an upper side in FIG. 6), and is connected to the first buffer portion 111 and the second buffer portion 112.

The first auxiliary layer 11A and the second auxiliary layer 11B are located on two opposite sides of both of the first buffer portion 111 and the second buffer portion 112 respectively, so as to connect and fix the first buffer portion 111 and the second buffer portion 112 as a whole, which is convenient for the buffer layer 11 to be assembled with other support layer structures, and improves an assembly efficiency of the display module 110.

For example, the first auxiliary layer 11A and the second auxiliary layer 11B may each be a material layer having adhesiveness, such as an adhesive layer. First, the first buffer portion 111 and the second buffer portion 112 are adhered on the first auxiliary layer 11A, and then the second auxiliary layer 11B is covered on surfaces the first buffer portion 111 and the second buffer portion 112 away from the first auxiliary layer 11A, so that the first buffer portion 111, the second buffer portion 112, the first auxiliary layer 11A and the second auxiliary layer 11B are adhered together to form a whole, which helps to improve an assembly efficiency of the buffer layer 11 and other support layer structures.

In some embodiments, referring to FIGS. 2 and 3A, the display module 110 further includes a back film 12 and a stress relief portion 13. The back film 12 is made of a flexible material and is attached to the back side of the display panel 20 for protecting and supporting the display panel 20. The stress relief portion 13 is used to reduce the stress generated by the second bendable region 20 of the display panel 20 during the bending process.

Referring to FIGS. 3A and 3B, the back film 12 includes a first back sub-film 121 and a second back sub-film 122. The first back sub-film 121 is disposed between the display panel 20 and the buffer layer 11, and corresponds to the main body region 201 and the first bendable region 202 of the display panel 20. The second back sub-film 122 is disposed on the back side of the display panel 20, and corresponds to the back region 204 of the display panel 20. The back film 12 exposes at least part of the second bendable region 203 of the display panel 20, which may not only reduce a bending resistance of the second bendable region 203 of the display panel 20, but also change a position of a stress neutral layer in the second bendable region 203 of the display panel 20 during the bending process, so as to avoid damage to the display panel 20.

In the first direction M, an edge of the first back sub-film 121 proximate to the second back sub-film 122 exceeds an edge of the second buffer portion 112 away from the first buffer portion 111, so that stress concentration at a boundary of the first bendable region 202 and the second bendable region 203 during the bending process of the display panel 20 is avoided, and a risk of breakage of the display panel at the boundary of the first bendable region 202 and the second bendable region 203 is reduced. The second back sub-film 122 is bent onto the back side of the display panel 20 with the back region 204 of the display panel 20.

Referring to FIGS. 2 and 3A, the stress relief portion 13 is disposed on a side of the first back sub-film 121 away from the display panel 20, is adhered to a portion of the first back sub-film 121 exceeding the second buffer portion 112, and is configured to absorb and release the stress received during the bending process of the second bendable region 203 of the display panel 20.

In some embodiments, referring to FIGS. 2, 3A and 3B, the display module 110 further includes a first adhesive layer 14, and the first adhesive layer 14 is disposed between the buffer layer 11 and the first back sub-film 121, so that the buffer layer 11 is adhered to the back side of the display panel 20 (for example, which is adhered between the buffer layer 11 and the back film 12). The stress relief portion 13 is adhered to a sidewall of the first adhesive layer 14 proximate to the second bendable region 203 of the display panel 20, and a sidewall of the buffer layer 11 proximate to the second bendable region 203 of the display panel 20.

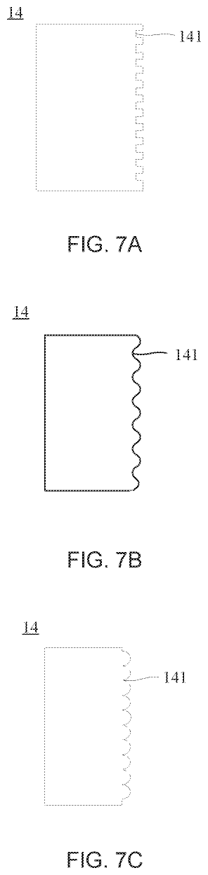

In some embodiments, referring to FIGS. 7A to 7C, an edge of the first adhesive layer 14 proximate to the second bendable region 203 of the display panel 20 has at least one groove structure 141. A part of the stress relief portion 13 is embedded in the at least one groove structure 141, so that an contact area between the stress relief portion 13 and the first adhesive layer 14, and an contact area between the stress relief portion 13 and the buffer layer 11 are increased, and a connection stability between the stress relief portion 13 and the first adhesive layer 14, and a connection stability between the stress relief portion 13 and the buffer layer 11 are improved. As a result, the stress relief portion 13 is prevented from falling off the sidewall of the first adhesive layer 14 or the sidewall of the buffer layer 11 that are proximate to the second bendable region 203 of the display panel 20. Shapes and forming ways of the groove structure 141 are various, which are not specifically limited here.

For example, referring to FIG. 7A, the edge of the first adhesive layer 14 proximate to the second bendable region 203 of the display panel 20 includes a plurality of notches arranged at intervals, and a notch forms a groove structure 141. A shape of the notch may be a rectangle, a trapezoid, or the like, which is not specifically limited here. Referring to FIG. 7B, the edge of the first adhesive layer 14 proximate to the second bendable region 203 of the display panel 20 may be wave-shaped, and a wave valley forms a groove structure 141. Alternatively, referring to FIG. 7C, the edge of the first adhesive layer 14 proximate to the second bendable region 203 of the display panel 20 includes a plurality of arc-shaped protrusions arranged consecutively, and a groove structure 141 is formed between two adjacent protrusions.

It will be noted that, shapes and forming ways of the groove structure 141 are various, which are not specifically limited here. For example, an edge of the second buffer portion 112 proximate to the second bendable region 203 is provided with groove structures 141 therein; alternatively, the edge of the second buffer portion 112 proximate to the second bendable region 203 of the display panel 20 exceeds the edge of the first adhesive layer 14 proximate to the second bendable region 203 of the display panel 20 in the first direction M; that is, edges, proximate to the second bendable region 203 of the display panel 20, of the second buffer portion 112 and the first adhesive layer 14, form a stepped structure.

In some embodiments, referring to FIG. 2, the display module 110 further includes a support layer 15 and a curved layer 16. The support layer 15 is disposed on a side of the buffer layer 11 away from the main body region 201 and the first bendable region 202 of the display panel 20. That is, as shown in FIGS. 3A and 3B, before the display module 110 is bent to form the curved surface, the support layer 15 covers the main body region 201 and the first bendable region 202 of the display panel 20. The display panel 20, the back film 12, the first adhesive layer 14, and the buffer layer 11 are all flexible structures, and the support layer 15 may provide rigid support for the flexible structures, so as to avoid unexpected deformation of the flexible structures, and ensure the display module 110 is able to have and maintain a certain shape. For example, the support layer 15 may be made of a SUS304 steel sheet.

The curved layer 16 is disposed on a side of the support layer 15 away from the buffer layer 11, and corresponds to the first bendable region 202 of the display panel 20. The curved layer 16 has a preset curvature, which is used as a reference for bending angles of other structural layers (the support component 10, the display panel 20 and the encapsulation component 30) of the display module 110.

In the case where the display module includes the support layer 15 and the curved layer 16, referring to FIG. 3B, the stress relief portion 13 may be adhered to a sidewall of the support layer 15 proximate to the second bendable region 203 of the display panel 20, and a sidewall of the curved surface layer 16 proximate to the second bendable region 203 of the display panel 20.

A connection relationship between the stress relief portion 13 and each support layer structure included in the support component is related to an assembling sequence of the display module 110. For example, in the assembling process of the display module 110, if the stress relief portion 13 is fabricated after the display panel 20, the back film 12, the first adhesive layer 14 and the buffer layer 11 are assembled, then, as shown in FIG. 3A, the stress relief portion 13 is adhered to the sidewall of the first adhesive layer 14 proximate to the second bendable region 203 of the display panel 20, and the sidewall of the buffer layer 11 proximate to the second bendable region 203 of the display panel 20. If the stress relief portion 13 is fabricated after the display panel 20, the back film 12, the first adhesive layer 14, the buffer layer 11, the support layer 15 and the curved layer 16 are assembled, then, as shown in FIG. 3B, the stress relief portion 13 is further adhered to the sidewall of the support layer 15 proximate to the second bendable region 203 of the display panel 20, and the sidewall of the curved surface layer 16 proximate to the second bendable region 203 of the display panel 20.

In some embodiments, referring to FIG. 2, the curved layer 16 is of a double-layer structure and is formed by folding a single-layer film structure in half. The sidewall of the curved layer 16 proximate to the second bendable region 203 of the display panel 20 has a curved surface. The curved layer 16 is of a double-layer structure, which may improve a bending strength of the curved layer 16, and avoid deformation when the display module 110 is bent, so that it is possible to ensure that each support layer structure of the display module 110 located on a side of the curved layer 16 proximate to the display panel 20 may be bent to form a preset curved surface. The curved layer 16 is formed by folding the single-layer film structure in half, which is simple in structure and convenient to manufacture. Moreover, the sidewall of the curved layer 16 has a curved surface, and the sidewall having the curved surface towards the side proximate to the second bendable region 203 of the display panel 20, so that a risk of scratching the back region 204 of the display panel 20 by the sidewall of the curved layer 16 proximate to the second bendable region 203 of the display panel 20 is reduced.

The second back sub-film 122 is located between the curved layer 16 and the back region of the display panel 20 and is adhered to the curved layer 16, so as to fix the back region 204 of the display panel 20 to the curved layer 16, and prevent the back region 204 from shaking.

In some embodiments, a material of the stress relief portion 13 includes at least one of a Tuffy adhesive, an acrylate-based adhesive, or a silicon-based adhesive. The materials described above are in a liquid state during coating, which facilitates sufficient contact and adhesion of the stress relief portion 13 with each sidewall of the support component 10. After the coating is completed, the material of the stress relief portion 13 in a liquid state is cured to form a flexible structure in a solid state.

Referring to FIG. 2, the display module 110 further includes a display driver chip 17 and a flexible circuit board 18. The display driver chip 17 is located on the back region 204 of the display panel 20, and is electrically connected to the display panel 20. The flexible circuit board 18 is disposed on the back region 204 of the display panel 20, and is electrically connected to the display panel 20. The display driver chip 17 and the flexible circuit board 18 are used to provide the display panel 20 with data signals required for displaying images.

Referring to FIG. 2, the display module 110 further includes a protective film 19, and the protective film 19 is disposed on a side of the display panel 20 away from the back film 12. The protective film 19 covers the second bendable region 203 of the display panel 20, and in the first direction M, an end of the protective film 19 extends toward the first bendable region 202 of the display panel 20, and another end of the protective film 19 extends toward the back region 204 of the display panel 20. The protective film 19 is able to change the position of the stress neutral layer in the second bendable region 203 of the display panel 20 during the bending process, so as to avoid damage to the display panel 20. For example, the protective film 19 may be a UV curable adhesive.

Referring to FIG. 2, the display module 110 further includes a polarizer 21, a second adhesive layer 22 and a cover plate 23. The polarizer 21 is disposed on a side of the display panel 20 away from the buffer layer 11, and corresponds to at least the main body region 201 of the display panel 20, which may reduce a light reflectivity of a light exit surface of the display module 110, and improve a display contrast of the display apparatus 100. The cover plate 23 is disposed on a side of the polarizer 21 away from the display panel 20, so as to protect the display panel 20. The second adhesive layer 22 is disposed between the polarizer 21 and the cover plate 23, so as to adhere the polarizer 21 to the cover plate 23.

The foregoing descriptions are merely specific implementations of the present disclosure, but the protection scope of the present disclosure is not limited thereto. Any person skilled in the art could conceive of changes or replacements within the technical scope of the present disclosure, which shall all be included in the protection scope of the present disclosure. Therefore, the protection scope of the present disclosure shall be subject to the protection scope of the claims.

1. A display module, comprising:
a display panel including a main body region, a first bendable region, a second bendable region, and a back region; wherein the first bendable region is located on a side of the main body region, the second bending area is located on a side of the first bendable region away from the main body region, and the back region is located on a side of the second bendable region away from the main body region; the main body region, the first bendable region, the second bendable region and the back region are connected in sequence; the first bendable region is bent toward a back side of the display panel to form a curved surface; the second bendable region is bent toward the back side of the display panel, and the back region is bent to be disposed opposite to the first bendable region;
a buffer layer stacked on the back side of the display panel and including a first buffer portion and a second buffer portion that are arranged side by side in a first direction the display panel; wherein the first buffer portion corresponds to the main body region, the second buffer portion corresponds to the first bendable region, and an elastic modulus of the second buffer portion is less than an elastic modulus of the first buffer portion; and
a stress relief portion disposed on a side of the second bendable region proximate to the buffer layer, wherein the stress relief portion is configured to absorb and release a stress generated during a bending process of the second bendable region of the display panel; wherein
the first direction is a direction perpendicular to a boundary line between the main body region and the first bendable region.

2. The display module according to claim 1, wherein the second buffer portion includes a plurality of buffer bars, each buffer bar extends in a second direction, and the plurality of buffer bars are arranged at intervals in the first direction; wherein
the second direction is an extending direction of the boundary line between the main body region and the first bendable region.

3. The display module according to claim 1, wherein the second buffer portion includes a plurality of holes arranged at intervals.

4. The display module according to claim 1, wherein a material of the first buffer portion includes polyethylene (PE) foam or polyester resin.

5. The display module according to claim 1, wherein the buffer layer further includes:
a first auxiliary layer disposed on a side of both of the first buffer portion and the second buffer portion away from the display panel and being connected to the first buffer portion and the second buffer portion; and
a second auxiliary layer disposed on a side of both of the first buffer portion and the second buffer portion proximate to the display panel and being connected to the first buffer portion and the second buffer portion.

6. The display module according to claim 1, further comprising:
a back film including a first back sub-film and a second back sub-film; wherein the first back sub-film is disposed between the display panel and the buffer layer, and corresponds to the main body region and the first bendable region of the display panel; the second back sub-film is disposed on the back side of the display panel, and corresponds to the back region of the display panel; an edge of the first back sub-film proximate to the second back sub-film exceeds an edge of the second buffer portion away from the first buffer portion in the first direction; wherein
the stress relief portion is disposed on a side of the first back sub-film away from the display panel, and is adhered to a portion of the first back sub-film exceeding the second buffer portion.

7. The display module according to claim 6, further comprising:
a first adhesive layer disposed between the buffer layer and the first back sub-film; wherein
the stress relief portion is adhered to a sidewall of the first adhesive layer proximate to the second bendable region of the display panel, and a sidewall of the buffer layer proximate to the second bendable region of the display panel.

8. The display module according to claim 7, wherein the edge of the first adhesive layer proximate to the second bendable region of the display panel has at least one groove structure, and a part of the stress relief portion is embedded in the at least one groove structure.

9. The display module according to claim 7, further comprising:
a support layer disposed on a side of the buffer layer away from the main body region and the first bendable region of the display panel; and
a curved layer disposed on a side of the support layer away from the buffer layer and corresponding to the first bendable region of the display panel.

10. The display module according to claim 9, wherein the stress relief portion is further adhered to a sidewall of the support layer proximate to the second bendable region of the display panel, and a sidewall of the curved layer proximate to the second bendable region of the display panel.

11. The display module according to claim 9, wherein the curved layer is of a double-layer structure and is formed by folding a single-layer film structure in half; the sidewall of the curved layer proximate to the second bendable region of the display panel has a curved surface.

12. The display module according to claim 9, wherein the second back sub-film is located between the curved layer and the back region of the display panel, and is adhered to the curved layer.

13. The display module according to claim 6, wherein a material of the stress relief portion includes at least one of a Tuffy adhesive, an acrylate-based adhesive or a silicon-based adhesive.

14. A display apparatus having a main display area and a curved surface area located on at least one side of the main display area;
the display apparatus comprising the display module according to claim 1, wherein the main body region of the display panel in the display module is located in the main display area, and the first bendable region of the display panel is located in the curved surface area.

15. The display module according to claim 3, wherein a shape of a radial section of each hole may be a circle or an ellipse.

16. The display module according to claim 1, wherein a material of the second buffer portion includes thermoplastic polyurethane elastomer rubber or silicone rubber.

17. The display module according to claim 5, wherein the first auxiliary layer and the second auxiliary layer are each a material layer having adhesiveness.

18. The display module according to claim 1, further comprising:
a protective film disposed on a side of the display panel away from the buffer layer, wherein the protective film covers the second bendable region of the display panel, and in the first direction, an end of the protective film extends toward the first bendable region of the display panel, and another end of the protective film extends toward the back region of the display panel.
